(19) United States
(12) Patent Application Publication
(10) Pub. No.: US 2009/0298429 A1
(43) Pub. Date: Dec. 3, 2009

(54) WIRELESS COMMUNICATION APPARATUS

(75) Inventor: Hideyuki NAKAGAWA, Koganei-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/472,248

(22) Filed: May 26, 2009

(30) Foreign Application Priority Data
May 27, 2008 (JP) 2008-138327
Sep. 30, 2008 (JP) 2008-255615

(51) Int. Cl. H04B 7/00

(52) U.S. Cl. 455/41.2

(57) ABSTRACT

A wireless communication apparatus includes: a communication module configured to perform close proximity wireless communication with an external device; a communication detector configured to detect whether the close proximity wireless communication is established by the communication module; an orientation detector configured to detect an orientation of the apparatus; and a processor configured to perform processing cooperatively with the communication module while the close proximity wireless communication is established based on the orientation detected by the orientation detector.

### CROSS REFERENCE TO RELATED APPLICATION(S)

The present disclosure relates to the subject matters contained in Japanese Patent Application No. 2008-138327 filed on May 27, 2008 and in Japanese Patent Application No. 2008-255615 filed on Sep. 30, 2008, which are incorporated herein by reference in its entirety.

### FIELD

The present invention relates to a wireless communication apparatus for performing close proximity wireless communication.

### BACKGROUND

In recent years, communication systems for performing communication over a relatively short distance, such as a non-contact communication system for performing non-contact communication using an IC chip or the like, are being widespread. Such a non-contact communication system for performing non-contact communication using an IC chip is characterized in that the system is capable of a limited number of functions, simple and easy to understand and that communication is made possible by an intuitive operation to move the devices to be communicated with each other in a close range. According to these characteristics, the system has a favorable usability.

In many cases, a single IC card provides a single service, such as electronic money. However, there is proposed to provide multiple types of services with a single IC card. An example of such system is disclosed in JP-T-2008-500602 (counterpart U.S. publication is: US 2008/0251586 A1). In a case where multiple application programs are executed in the system, an application program may be executed against a user's intention.

In the publication JP-T-2008-500602, a semiconductor memory card for performing non-contact communication with a reader/writer is disclosed. The semiconductor memory card includes a direction obtaining module for obtaining two or more first access direction types for the reader/writer of the semiconductor memory card; a condition management module for storing and managing access conditions including two or more second access direction types; a condition determination module for comparing the two or more first access direction types captured using the direction obtaining module with the two or more second access direction types included in the access conditions stored in the condition management module and for determining whether there is coincidence between the first access direction types and the second access direction types; and an execution 5 module for executing a predetermined application program in a case where it is determined using the condition determination module that there is coincidence between the first access direction types and the second access direction types, whereby the application program is executed after the 10 intention of the user has been confirmed.

However, according to the method described in the publication JP-T-2008-500602, the comparison of the access direction types needs to be performed for multiple times, and user's operation becomes complicated. When an attempt is is made to execute a predetermined application program, the user is required to memorize at least two patterns for each access direction type in each application program, whereby operation becomes significantly burdensome to the user.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a view showing a configuration of a wireless communication system in which a wireless communication apparatus according to a first embodiment of the present invention is used.

FIG. 2 is a view showing a configuration of the wireless communication apparatus according to the first embodiment of the present invention.

FIG. 3 is a flowchart showing a flow of the processing of the wireless communication apparatus according to the first embodiment of the present invention.

FIG. 4 is a view showing an example of a display screen displayed on the wireless communication apparatus according to the first embodiment of the present invention.

FIG. 5 is a view showing the configuration of a wireless communication apparatus according to a second embodiment of the present invention.

FIG. 6 is a flowchart showing the flow of the processing of the wireless communication apparatus according to the second embodiment of the present invention.

FIG. 7 is a perspective view showing a wireless communication system including a wireless communication apparatus according to a third embodiment of the present invention.

FIG. 8 is a perspective view showing the wireless communication apparatus according to the third embodiment of the present invention.

FIG. 9 is a view showing the configuration of the wireless communication apparatus according to the third embodiment of the present invention.

FIG. 10 is a view showing the protocol stack used in the wireless communication apparatus according to the third embodiment of the present invention.

FIG. 11 is a flowchart showing the flow of the processing of the wireless communication apparatus according to the third embodiment of the present invention;

FIG. 12 is a view showing the configuration of a wireless communication apparatus according to a fourth embodiment of the present invention.

FIG. 13 is a flowchart showing the flow of the processing of the wireless communication apparatus according to the fourth embodiment of the present invention.

FIG. 14 is a view showing the configuration of a wireless communication apparatus according to a fifth embodiment of the present invention.

### DETAILED DESCRIPTION OF THE EMBODIMENTS

Embodiments of a wireless communication apparatus according to the present invention will be described below referring to the accompanying drawings.

### First Embodiment

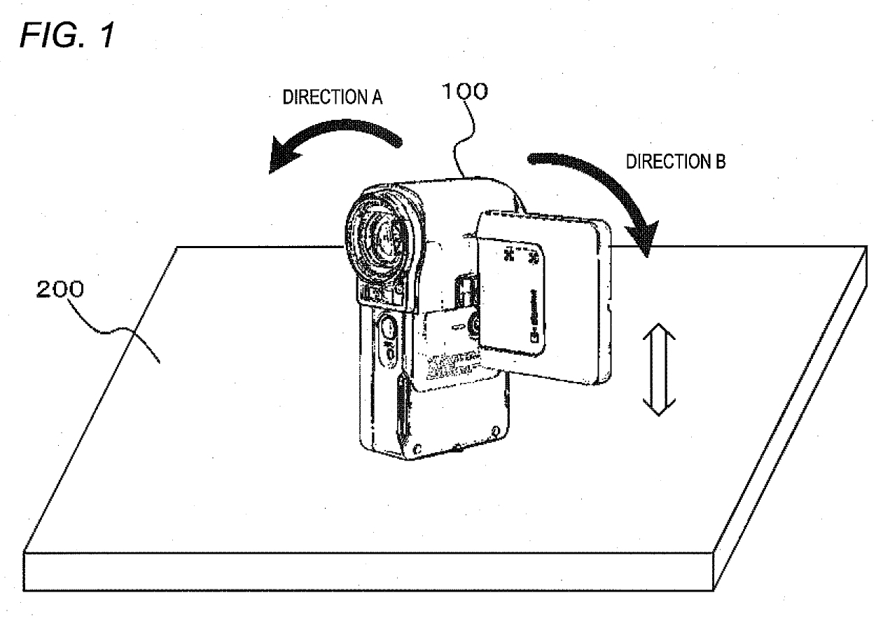

FIG. 1 is a view showing the configuration of a wireless communication system in which a portable device 100 according to a first embodiment of the present invention is used. The portable device 100 has a function of performing wireless communication with a host device 200. In this embodiment, it is explained that the portable device 100 can communicate with the host device 200 based on close proximity wireless communication over a communicable distance of approximately 3 cm or less, for example. A system conforming to TransferJet serving as a standard being developed at present is taken as an example of this close proximity wireless communication system. TransferJet is characterized in that communication is performed over a very short distance and that a large capacity of communication is possible at a relatively high speed of several hundred Mbps. Hence, various data, such as still images and moving images, can be transmitted and multiple functions instead of a single function can be implemented using the close proximity wireless communication by activating various applications.

However, when an attempt is made to implement various functions by activating various applications, user interface usually becomes complicated, and the operation burden imposed on the user increases. Therefore, the portable device 100 according to this embodiment performs various kinds of processing depending on how an orientation (posture) of the portable device is moved, whereby the operation of the user interface is prevented from becoming complicated.

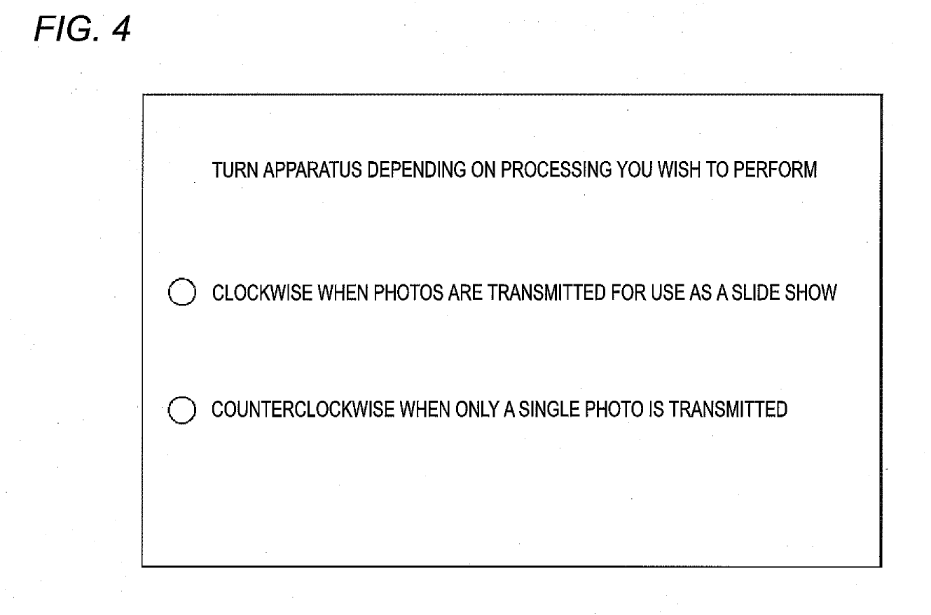

In the first embodiment, when the portable device 100 and the host device 200 are located sufficiently close to each other and the intensity of the radio wave transmitted therebetween becomes high so that communication is possible, the portable device 100 displays a menu screen (an example is shown in FIG. 4 described later). Then, processing to be performed using the close proximity wireless communication is selected depending on a direction (direction A or direction B) toward which the portable device 100 is moved by the user. The details of the processing will be described later.

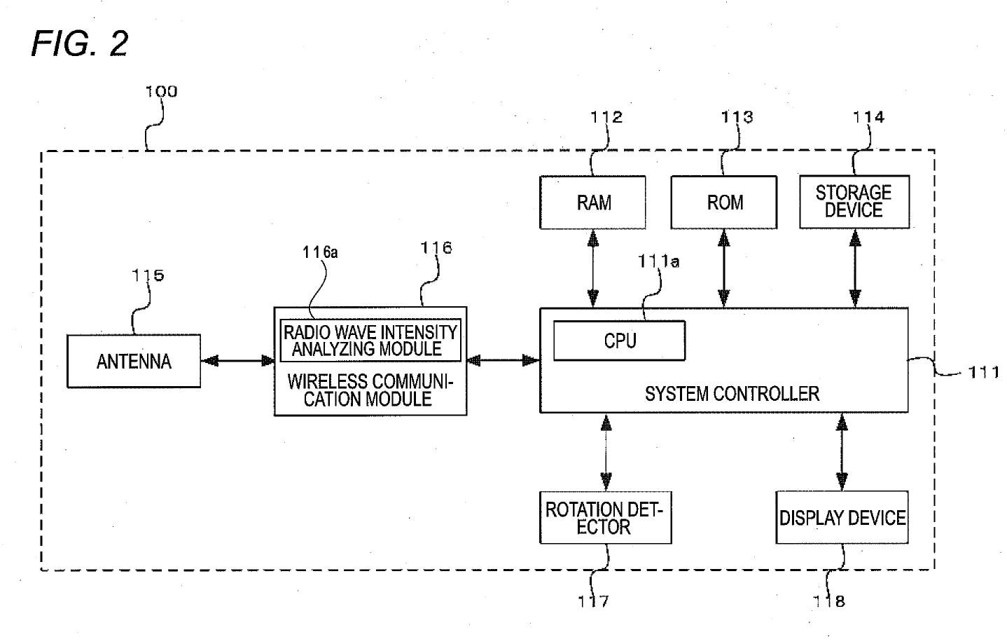

The configuration of the portable device 100 will be described below referred to FIG. 2. The portable device 100 is equipped with a system controller 111, a RAM (random-access memory) 112, a ROM (read-only memory) 113, a storage device 114, an antenna 115, a wireless communication module 116, a rotation detector 117, and a display device 118. In addition to these components, in a case where the portable device 100 is configured as a digital camera, the device may further be equipped with lenses and an image capturing modules. In a case where the portable device 100 is configured as a mobile phone, the device may further be equipped with a speaker, a microphone, a telephone communication module, an audio data reproducing module and an image capturing modules. Such additional components are not shown in the accompanying drawings.

The system controller 111 is provided with a processor (CPU: central processing unit) 111a and a system bus and controls the entire system of the portable device 100. The CPU 111a is a processor for controlling the operation of the portable device 100 and runs various programs that are read from the ROM 113 and loaded on the RAM 112, for example. Such programs to be executed on the CPU 111a have various functions, for example, a function in which data, such as still images and moving images, stored in the storage device 114 is transmitted to the host device 200 one piece at a time or multiple pieces consecutively to be displayed as a slide show. Furthermore, such programs to be executed on the CPU 111a also have various functions, for example, a function in which these functions are switched depending on the rotation direction of the portable device 100 detected using the rotation detector 117.

The RAM 112 is a volatile storage medium and temporarily stores data received from the wireless communication module 116, data to be processed in the rotation detector 117 or programs to be executed on the CPU 111a. The ROM 113 is a nonvolatile storage medium and stores programs to be executed on the CPU 111a, for example.

The storage device 114 may be, for example, a nonvolatile storage medium configured by an HDD (hard disk drive), a large-capacity flash memory or the like for storing user data, such as still images/moving images and audio data. Data to be transmitted to the host device 200 or data to be received from the host device 200 is stored in the storage device 114.

The antenna 115 is an antenna for performing communication with the host device 200 in conformance with the close proximity wireless communication system, such as TransferJet. The antenna 115 is disposed near a face of the portable device 100 that can be placed easily on the host device 200, such as the bottom face of the portable device 100.

The wireless communication module 116 controls the close proximity wireless communication that is performed via the antenna 115. The wireless communication module 116 demodulates a radio wave received via the antenna 115 into digital data, modulates digital data to be transmitted and transmits the digital data from the antenna 115. Furthermore, the wireless communication module 116 has a radio wave intensity analyzing module 116a and has a function of detecting the intensity of a radio wave received via the antenna 115. When a radio wave having a constant intensity value or more is detected using the radio wave intensity analyzing module 116a of the portable device 100, the portable device 100 can communicate with the host device 200 and starts processing, such as communication connection and the display of the menu screen.

The rotation detector 117 detects the rotation of the portable device 100. For example, on the basis of the position (orientation) of the portable device 100 when the portable device 100 is placed on the host device 200 for the first time, the rotation detector 117 detects the rotation direction (relative rotation direction) of the portable device 100 when the portable device 100 is placed on the host device 200 at a second time, using a gyro sensor or the like. In other words, in the case of the example shown in FIG. 1, the rotation detector 117 detects whether the rotation direction of the portable device 100 from the placement position (original orientation) of the first time (the state shown in FIG. 1) to the placement position of the second time is the direction A or the direction B and then informs the result of the detection to the system controller 111. The system controller 111 performs processing being different depending on whether the detected rotation direction is the direction A or the direction B.

The display device 118 is provided with an LCD (liquid crystal display) or an organic EL (electroluminescence) display, for example, and displays the menu screen and images taken by the portable device 100. In addition, the display device 118 has a function of displaying a display screen, such as the display screen shown in FIG. 4 described later, and presenting information, such as processing that can be performed and the rotation direction for performing the processing, to the user. Although the correspondence between the rotation direction and the processing to be performed is informed to the user through display in the first embodiment, the portable device 100 is not limited to this configuration. The correspondence therebetween may also be informed through audio announcement using a speaker, for example.

Although an image-taking apparatus (a camcorder, a digital camera or the like) is shown as the portable device 100 in the example shown in FIG. 1, any apparatus may also be used, provided that the apparatus has a function of transmitting data stored in a storage medium through wireless communication. Examples of such an apparatus may include a mobile phone capable of transmitting the data of taken images, the data of an address book, etc. and a PC (personal computer) for performing data transmission.

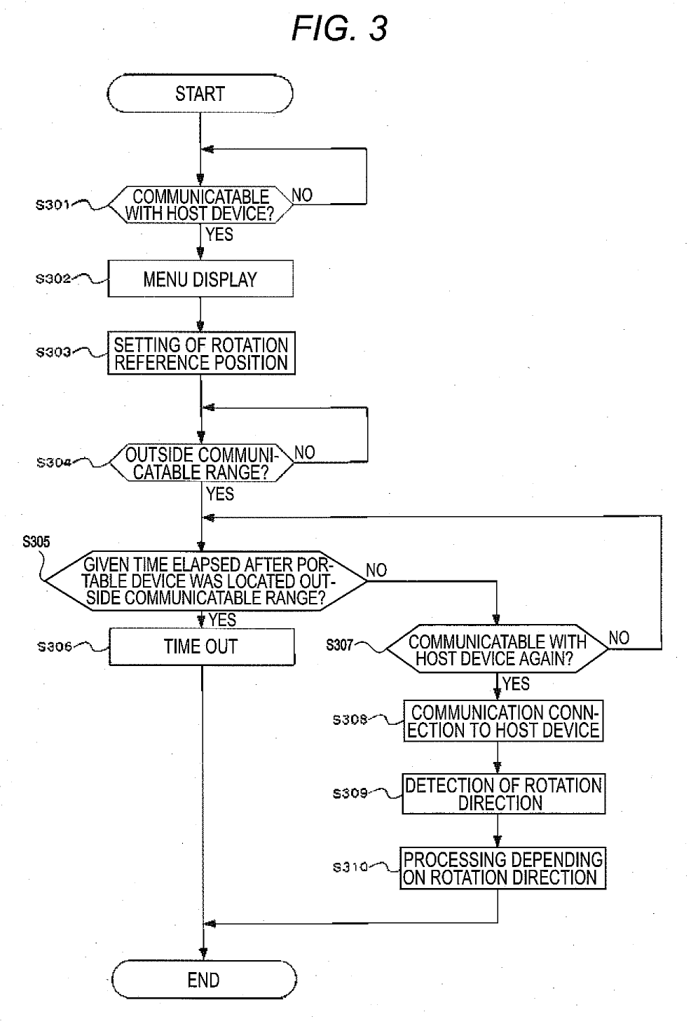

Next, the operation of the portable device 100 will be described below referred to FIG. 3. FIG. 3 is a flowchart showing an example of the processing performed by the portable device 100.

While the portable device 100 operates, the radio wave intensity analyzing module 116a periodically detects the intensity of the radio wave received using the antenna 115 disposed on the bottom face (placement face) of the portable device 100, for example, and determines whether the intensity of the radio wave is a constant value (threshold value) or more and the portable device 100 can communicate with the host device 200 (at step S301).

In a case where it is determined that the portable device 100 has become communicable with the host device 200 (Yes at step S301), the system controller 111 displays such a menu screen as shown in FIG. 4 on the display device 118 (at step S302). The menu screen shown as an example in FIG. 4 presents processing that can be performed and the rotation directions corresponding thereto. More specifically, in a case where photos stored in the storage device 114 are transmitted to be displayed as a slide show (in a case where multiple image files are transmitted consecutively to the host device 200), the menu screen informs the user that the portable device 100 should be turned in the clockwise direction. Furthermore, in a case where only one photo stored in the storage device 114 is transmitted (in a case where one image file is transmitted to the host device 200) the menu screen informs the user that the portable device 100 should be turned in the counterclockwise direction.

The system controller 111 captures the current orientation (rotation reference position) of the portable device 100 using the rotation detector 117 (at step S303) This original orientation serves as the reference position (orientation) for the detection, and the relative rotation direction detected at step S309 described later is the rotation direction with respect to the reference position.

Next, the system controller 111 determines whether the intensity of the radio wave detected using the radio wave intensity analyzing module 116a is the predetermined threshold value or less and the portable device 100 is located outside the communicable range of the host device 200 (at step S304). In a case where it is determined that the portable device is not located outside the communicable range (No at step S304), the intensity detection of the radio wave continues while the status of the system remains unchanged (at step S304).

In a case where it is determined that the portable device 100 has been located once outside the communicable range of the host device 200 (Yes at step S304), the system controller 111 determines whether a given time has elapsed after the portable device 100 was located outside the communicable range (at step S305). In a case where it is determined that the given time or more has elapsed after the portable device 100 was located outside the communicable range (Yes at step S305), the system controller 111 determines that a time-out has occurred and completes the processing (at step S306).

In a case where it is determined that the given time has not been elapsed after the portable device 100 was located outside the communicable range (No at step S305), the system controller 111 determines whether the intensity of the radio wave detected using the radio wave intensity analyzing module 116a is the predetermined threshold value or more and the portable device 100 has become communicable with the host device 200 again (at step S307). In a case where it is determined that the portable device 100 has not yet become communicable with the host device 200 (No at step S307), the process returns to step S305, and the system controller 111 continues the detection of the time having elapsed after the portable device 100 was located outside the communicable range.

In a case where it is determined that the portable device 100 has become communicable with the host device 200 again (Yes at step S307), the system controller 111 controls the wireless communication module 116 to establish communication connection to the host device 200 (at step S308). Furthermore, the system controller 111 detects the current direction of the portable device 100 using the rotation detector 117 and detects the relative rotation direction with respect to the rotation reference position detected at step S303 (at step S309). The system controller 111 performs the processing corresponding to the detected rotation direction (at step S310). For example, in the examples shown in FIGS. 1 and 4, in a case where the portable device 100 is rotated in the clockwise direction (direction A), multiple image files stored in the storage device 114 are read consecutively and transmitted for use as a slide show from the wireless communication module 116 to the host device 200, and in a case where the portable device 100 is rotated in the counterclockwise direction (direction B), a single image file stored in the storage device 114 is read and transmitted from the wireless communication module 116 to the host device 200.

In the first embodiment, the rotation direction is detected, and the user can perform a desired operation depending on the direction. Hence, even if multiple kinds of processing can be performed using the close proximity wireless communication, such as TransferJet, the multiple kinds of processing (applications) can be used by simple operation while the menu is avoided from becoming complicated, for example.

Furthermore, in the first embodiment, in a case where the portable device 100 has become communicable with the host device 200 at a first time, the system controller 111 displays the menu screen and obtains the reference position. In a case where the portable device 100 has become communicable with the host device 200 at a second time, the system controller 111 detects the relative rotation direction from the reference position of the first time and performs the processing corresponding to the rotation direction. In other words, since the portable device 100 can be operated only on the basis of the relative positional relationship with the host device 200, the portable device 100 is easy to operate intuitively.

Moreover, in the first embodiment, the processing to be performed is determined depending on the change in the orientation of the portable device 100 in the vicinity of the communicable range of the host device 200; the change occurs when the portable device 100 is located outside the communicable range once. Operation that is easy to understand intuitively can thus be provided for the user by letting the user locate the portable device outside the communicable range once.

In the first embodiment, the reference position is captured (at step S303 in FIG. 3), the portable device 100 is located outside the communicable range once and then located inside the communicable range again, and the position of the portable device is captured (at step S309 in FIG. 3), whereby the rotation direction thereof is detected. However, the portable device 100 is not limited to the above-mentioned method. For example, it may also be possible that, without locating the portable device 100 outside the communicable range, the rotation reference position of the portable device is obtained at a first timing, the direction of the portable device is detected again at a second timing after the given time has elapsed after obtaining the reference position, and the rotation direction of the portable device 100 is detected. In this case, since the user can perform operation by changing the orientation of the portable device 100 without locating the portable device outside the communicable range once, the portable device 100 can be operated with less amount of motion.

### Second Embodiment

In the first embodiment, processing is performed depending on the rotation direction that is detected for the second time on the basis of the reference position captured at the first time. However, the portable device 100 is not limited to this configuration. For example, it may also be possible that the orientation (absolute direction) of the portable device 100 or the relative positional relationship of the portable device with respect to the host device 200 is detected using magnets or the like and that processing is performed depending on the orientation.

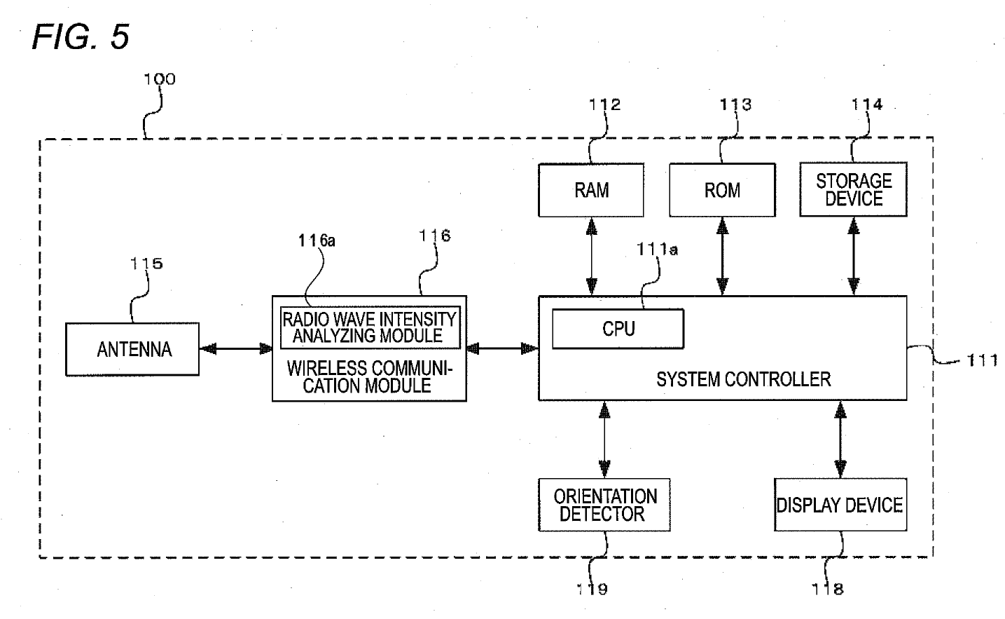

FIG. 5 is a view showing the configuration of a portable device 100 according to a second embodiment. Components similar to those of the first embodiment are designated by the same numerals, and the descriptions thereof are omitted.

The portable device 100 according to the second embodiment differs from the portable device 100 according to the first embodiment in that an orientation detector 119 is provided instead of the rotation detector 117. The rotation detector 117 according to the first embodiment detects the relative rotation direction at the second timing (at the timing when the portable device 100 has become communicable for the second time) with respect to the reference position captured at the first timing (at the timing when the portable device 100 has become communicable at the first time) using a gyro sensor or the like. However, the orientation detector 119 according to the second embodiment detects the absolute direction (orientation) of the portable device 100 or the relative positional relationship of the portable device 100 with respect to the host device 200 using magnets, a gyro sensor or the like.

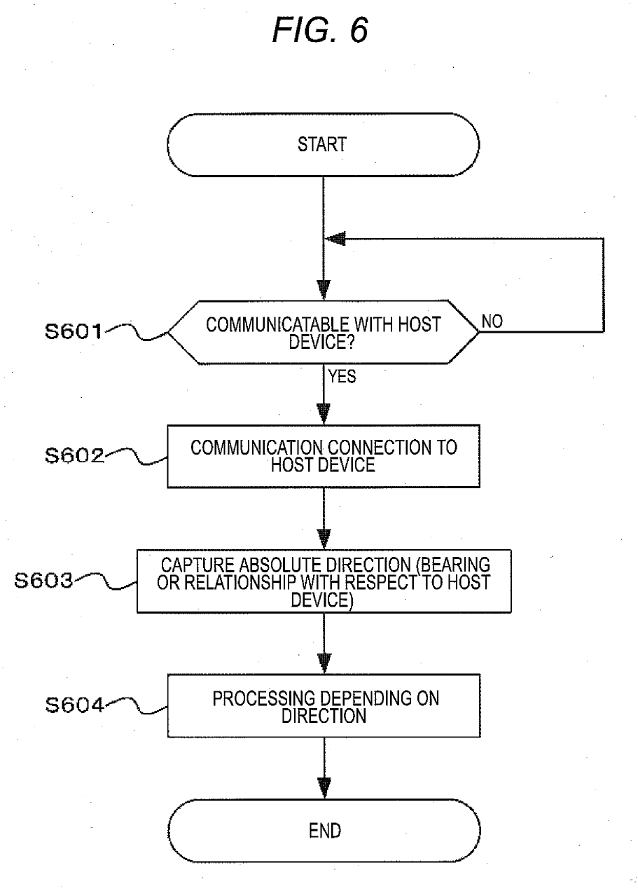

Next, the flow of the processing of the portable device 100 according to the second embodiment will be described below referred to FIG. 6. FIG. 6 is a flowchart showing the flow of the processing of the portable device 100 according to the second embodiment.

While the portable device 100 operates, the radio wave intensity analyzing module 116a always detects the intensity of the radio wave received using the antenna 115 disposed on the bottom face (placement face) of the portable device 100, for example, and always determines whether the intensity of the radio wave is a constant value (threshold value) or more and the portable device 100 can communicate with the host device 200 (at step S601).

In a case where it is determined that the portable device 100 has become communicable with the host device 200 (Yes at step S601), the system controller 111 controls the wireless communication module 116 to establish communication connection to the host device 200 (at step S602). The system controller 111 detects the current direction of the portable device 100 using the orientation detector 119 (at step S603) and performs processing corresponding to this direction (at step S604). The direction of the portable device 100 is herein defined to indicate the bearing thereof or the relative direction of the portable device 100 with respect to the host device 200 (for example, whether the direction of the portable device 100 is parallel with the long-wise direction or the short-wise direction of the host device 200).

In the second embodiment, the original orientation of the portable device 100 at the time when it has become communicable is detected, and the user can perform a desired operation depending on the direction. Hence, even if multiple kinds of processing can be performed using the close proximity wireless communication, such as TransferJet, the multiple kinds of processing (applications) can be used by simple operation while the menu is avoided from becoming complicated, for example.

In the second embodiment, the processing depending on the orientation (absolute direction) is performed without obtaining the reference position of the portable device 100. Hence, the user can perform processing by simply placing the portable device 100 only once, whereby the operation is made easy.

### Third Embodiment

In the first and second embodiments, it is described that a single antenna 115 is provided. However, the portable device 10 is not limited to this configuration, and multiple antennas may also be provided. A third embodiment in which multiple antennas are provided will be described below. In the third embodiment, components similar to those of the first and second embodiments are designated by the same numerals, and the descriptions thereof are omitted.

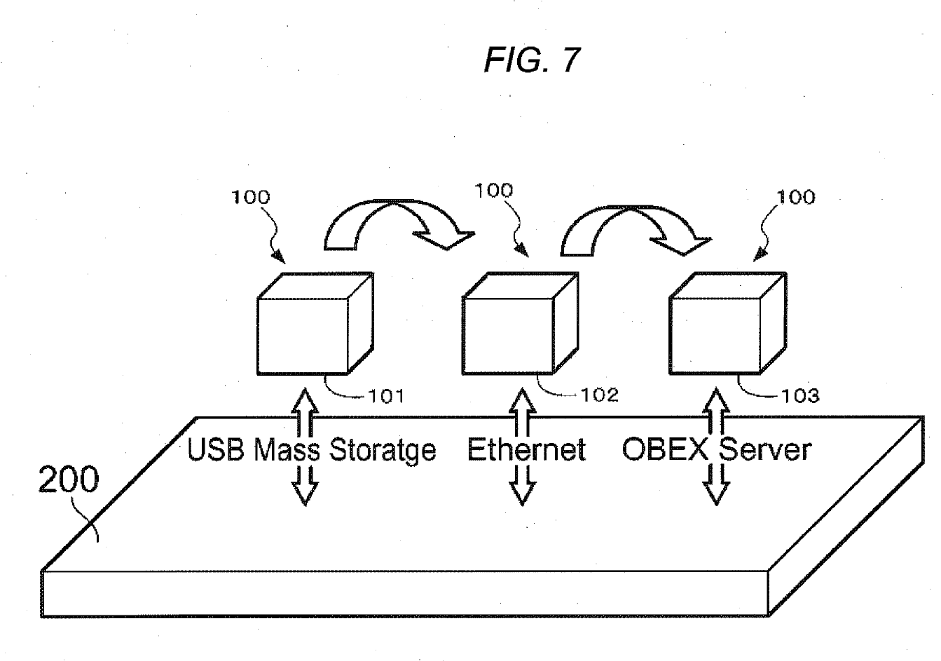

FIG. 7 is a perspective view showing a portable device 100 and a host device 200 according to the third embodiment. The portable device 100 and the host device 200 according to the embodiment communicate with each other based on the close proximity wireless communication, such as TransferJet. The communicable range of the close proximity wireless communication according to the third embodiment is set to have a maximum range, which is approximately 1 cm to 10 cm. When the portable device 100 is moved close to the host device 200 until they are almost in contact with each other, wireless connection is established, and data communication is performed.

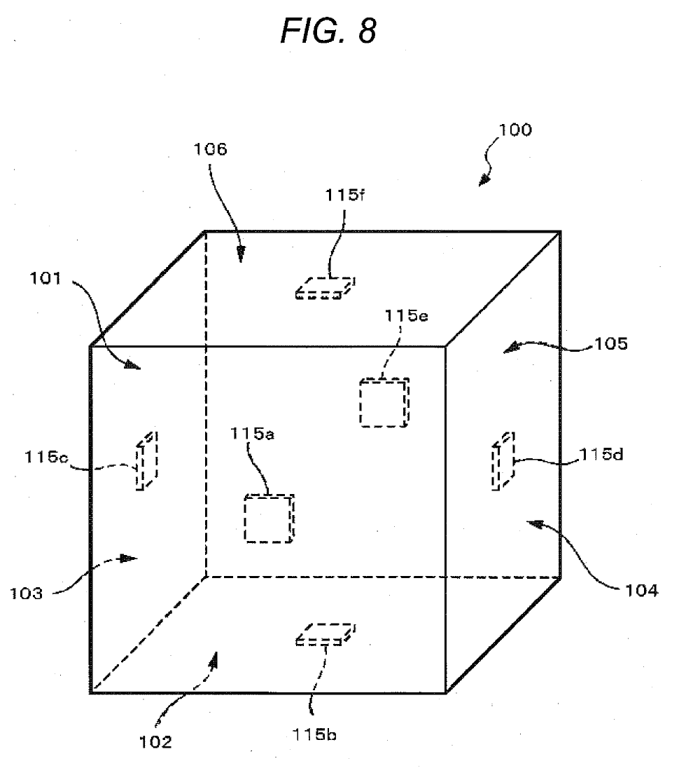

FIG. 8 is a perspective view showing the portable device 100 according to the third embodiment. As shown in FIG. 8, it is assumed that the portable device 100 according to the third embodiment has an approximately cubic shape. Antennas sections 115a to 115f are disposed near the face sections 101 to 106 (near the inner walls of the faces) of the cubic shape of the portable device 100. The following application programs are respectively correlated with the face sections 101 to 106 (and the antennas 115a to 115f disposed close thereto).

Face section 101: an application program for USB Mass Storage

Face section 102: an application program for Ethernet (registered trademark)

Face section 103: an application program for OBEX Client

Face section 104: an application program for OBEX Server

Face section 105: spare (unassigned)

Face section 106: spare (unassigned)

When the user locates one of the face sections 101 to 106 of the portable device 100 close to the host device 200, the system controller 111 activates the application program that is correlated with the face section nearest to the host device 200 and performs the close proximity wireless communication using the antenna located near the face section.

In the example shown in FIG. 8, when the face section 101 is located close to the host device 200 disposed in the direction of gravity, the system controller 111 activates the application program for USB Mass Storage, whereby the portable device 100 serves as a device functioning to perform as a USB Mass Storage. Similarly, when the face section 102 is located close to the host device 200 disposed in the direction of gravity, the system controller 111 activates the application program for Ethernet (registered trademark) whereby the portable device 100 serves as a device that can be communicated using the functions of Ethernet (registered trademark). Furthermore, when the face 103 is located close to the host device 200 disposed in the direction of gravity, the system controller 111 activates the application program for OBEX Client, whereby the portable device 100 serves as a device functioning as an OBEX Client. Moreover, when the face 104 is located close to the host device 200 disposed in the direction of gravity, the system controller 111 activates the application program for OBEX Server, whereby the portable device 100 serves as a device functioning as an OBEX Server.

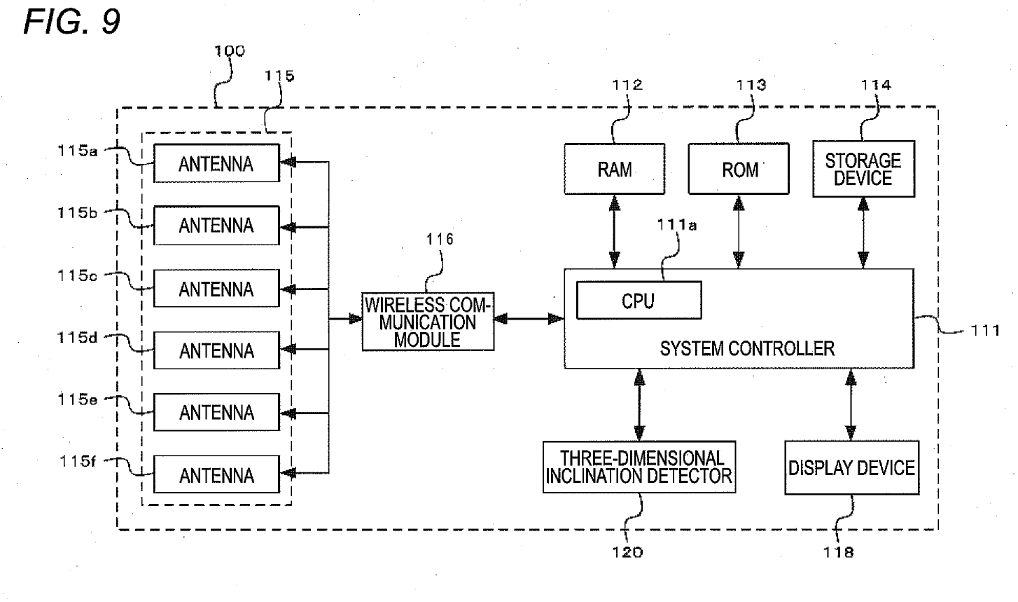

FIG. 9 is a view showing the configuration of the portable device 100 according to the third embodiment. As shown in FIG. 9, the portable device 100 according to the third embodiment is equipped with the antennas 115a to 115f and a three-dimensional inclination detector 120.

The system controller 111 controls the entire system of the portable device 100. The CPU 111a provided in the system controller 111 is a processor for controlling the operation of the portable device 100 and executes the application program for USB Mass Storage, the application program for Ethernet (registered trademark), the application program for OBEX Client, the application program for OBEX Server, etc. in addition to the operating system thereof.

The ROM 113 stores information regarding which application programs are correlated with the respective face sections 101 to 106 (the antennas 115a to 115f) and also stores programs for controlling the various function blocks of the portable device 100.

The antennas 115a to 115f, each serving as the antenna 115, are disposed near the face sections 101 to 106, respectively. The wireless communication module 116 controls wireless communication using one of the antennas 115a to 115f. In this embodiment, the wireless communication module 116 stops power supply to the antennas other than the antenna that is detected to have been oriented in the direction of gravity using the three-dimensional inclination detector 120, thereby performing control so that the close proximity wireless communication performed using the antenna oriented in the direction of gravity is not disturbed.

The three-dimensional inclination detector 120 may be implemented by a gyro sensor, an acceleration sensor or the like and is used to detect the inclinations of the portable device 100 in the forward/backward, up/down and right/left directions. The three-dimensional inclination detector 120 detects a direction toward which the portable device 100 is oriented.

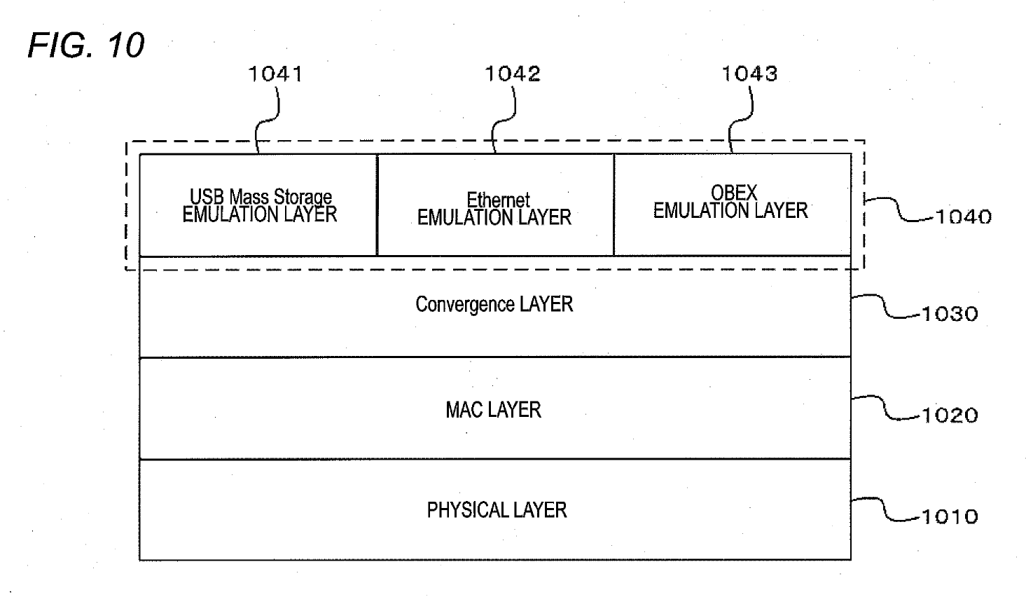

FIG. 10 is a view showing the protocol stack used in the portable device 100. As shown in FIG. 10, the protocol stack of the portable device 100 includes a physical layer 1010, a MAC layer 1020, a Convergence layer 1030 and an emulation layer 1040. The physical layer 1010 is a layer in which a physical transmission system and a physical connection method are determined, and the MAC layer 1020 is a layer in which the structure of frames to be transmitted and received and a method for gaining access to media are determined. The Convergence layer 1030 is a layer in which transmitted data received from the emulation layer 1040 is transferred to the MAC layer 1020, a lower-order layer, and data received from the MAC layer 1020 is transferred to the emulation layer 1040, a higher-order layer.

The emulation layer 1040 has a USB Mass Storage emulation layer 1041, an Ethernet (registered trademark) emulation layer 1042 and an OBEX emulation layer 1043, capable of being viewed as USB Mass Storage, Ethernet (registered trademark) and OBEX, respectively, for higher-order application programs (not shown). Hence, the higher-order application programs can use the functions of these emulation layers 1041, 1042 and 1043 by performing data communication via the Convergence layer 1030, the MAC layer 1020 and the physical layer 1010.

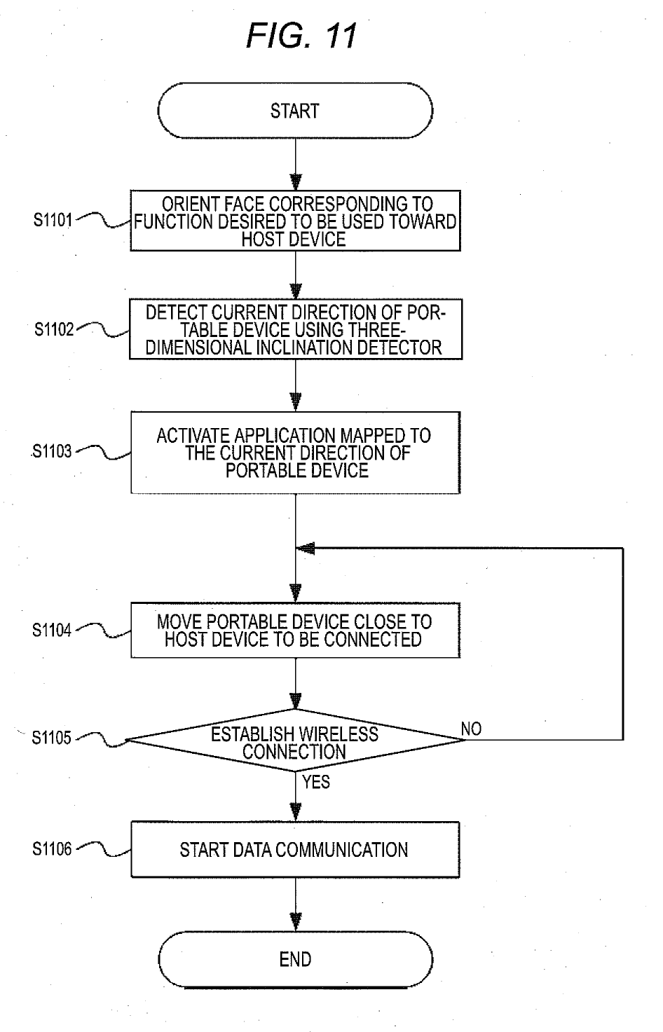

The operation of the portable device 100 according to the third embodiment will be described below. FIG. 11 is a flowchart showing the operation of the portable device 100 according to the third embodiment. As shown in FIG. 11, the portable device 100 is placed on the host device 200 by the user so that one of the face sections 101 to 106 correlated with the respective application programs is oriented in the direction of gravity in which the host device 200 is positioned (at step S1101).

When the portable device 100 is placed on the host device 200, the three-dimensional inclination detector 120 detects which one of the face sections 101 to 106 of the portable device 100 is oriented in the direction of gravity (in other words, which one is oriented toward the host device 200) (at step S1102). The system controller 111 activates the application program that is correlated with the face section oriented in the direction of gravity on the basis of the detection signal of the three-dimensional inclination detector 120 (at step S1103). As a result, a function is selected from among the functions of the portable device 100. The display device 118 displays information regarding the application program (function) being executed, and the information is notified to the user. Audio announcement or the like may also be used for notifying the information to the user.

Next, when the portable device 100 in which the selected application program has been activated is moved close to the host device 200 (at step S1104), wireless connection is established (at step S1105), and data communication is performed according to the application program (at step S1106).

The portable device 10 according to the third embodiment can provide the user a method wherein an application program is correlated with a face through which the portable device 100 and the host device 200 are located close to each other, that is, the direction of the portable device 100, whereby the face to be located close to the host device 200, that is, the application program corresponding thereto, can be selected, and function selection can be implemented without impairing intuitive operation of moving the two devices close to each other. Consequently, multiple kinds of processing (applications) can be used by simple operation using the close proximity wireless communication, such as TransferJet, while the menu is avoided from becoming complicated, for example.

In addition, according to the third embodiment, the three-dimensional inclination detector 120 detects which one of the face sections 101 to 106 of the portable device 100 is oriented in the direction of gravity, thereby detecting the direction of the portable device 100. Hence, the direction of the portable device 100 can be detected surely using a simple method.

Furthermore, since the display device 118 indicates the selected application program, the user can surely perform the close proximity wireless communication according to the desired application program.

Moreover, the antenna 115 has the antennas 115a to 115f that are provided near the face sections 101 to 106, respectively, and correlated with the respective application programs. Hence, even if the portable device 100 has a large thickness in the direction toward the host device 200 and even if the portable device 100 is oriented in various directions, the portable device 100 can perform the close proximity wireless communication with the host device 200 by surely transmitting and receiving the radio wave.

In the third embodiment, the application programs for USB Mass Storage, OBEX Client/Server, etc. are correlated with the respective face sections of the portable device. However, the present invention is not limited to this configuration. For example, multiple kinds of processing to be performed may be correlated with the respective face sections as in the cases of the first and second embodiments.

### Fourth Embodiment

A fourth embodiment according to the present invention will be described below. In the fourth embodiment, components similar to those of the first to third embodiments are designated by the same numerals, and the descriptions thereof are omitted.

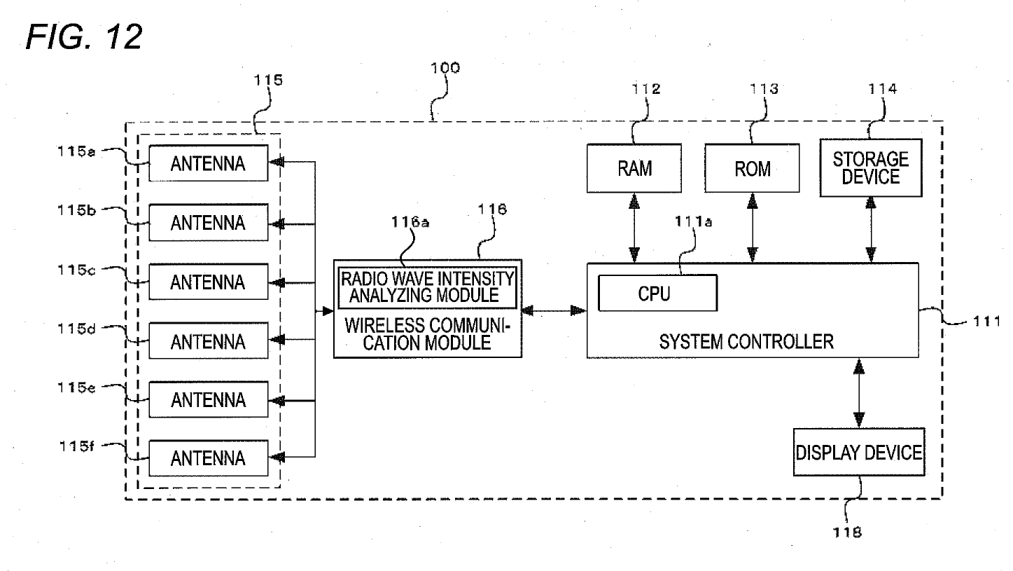

FIG. 12 is a block diagram showing the configuration of a portable device 100 according to the fourth embodiment. The fourth embodiment differs from the third embodiment in that the portable device 100 is not equipped with the three-dimensional inclination detector 120 but is equipped with the radio wave intensity analyzing module 116a in the wireless communication module 116.

The radio wave intensity analyzing module 116a analyzes the intensity of the radio waves received using the antennas 115a to 115f and detects the direction of the portable device 100. During the close proximity wireless communication, the radio wave intensity analyzing module 116a turns on only the antenna having the highest radio wave receiving intensity and turns off the other antennas. The system controller 111 activates the application program correlated with the antenna having the highest radio wave receiving intensity among the antennas 115a to 115f.

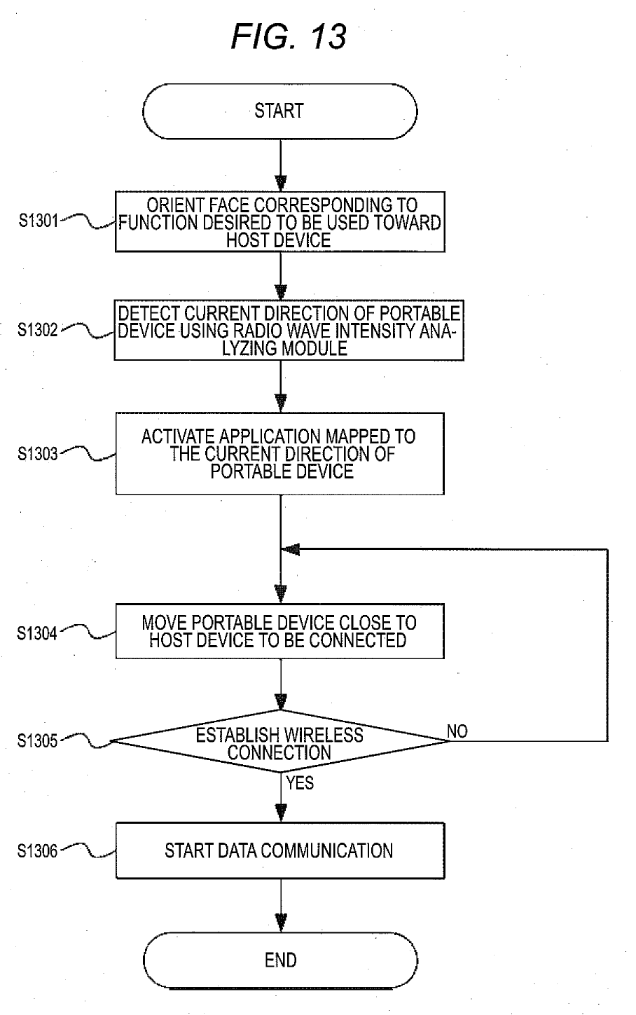

The operation of the portable device 100 according to this embodiment will be described below. FIG. 13 is a flowchart showing the operation of the portable device 100 according to the fourth embodiment.

As shown in FIG. 13, one of the face sections 101 to 106 correlated with the respective application programs of the portable device 100 is oriented in the direction toward the host device 200 by the user (at step S1301).

The radio wave intensity analyzing module 116a analyzes the intensity of the radio waves received using the antennas 115a to 115f and detects the direction of the portable device 100 (at step S1302). On the basis of the detection signal of the radio wave intensity analyzing module 116a, the system controller 111 activates the application program correlated with the antenna having the highest radio wave receiving intensity among the antennas 115a to 115f (at step S1303). As a result, a function is selected from among the functions of the portable device 100. The following steps S1304 to S1306 are performed similarly to the steps S1104 to S1106 in the third embodiment, and the descriptions thereof are omitted.

In the fourth embodiment, the direction of gravity is not used as the reference for the detection of the direction of the portable device 100, but the radio wave intensity analyzing module 116a analyzes the intensity of the radio waves received using the antennas 115a to 115f to detect the direction of the portable device 100. Hence, even in a case where the disposition face of the antenna of the host device 200 is not set so as to be perpendicular to the direction of gravity, a desired application program can be selected surely.

### Fifth Embodiment

A fifth embodiment according to the present invention will be described below. In the fifth embodiment, components similar to those of the first to fourth embodiments are designated by the same numerals, and the descriptions thereof are omitted.

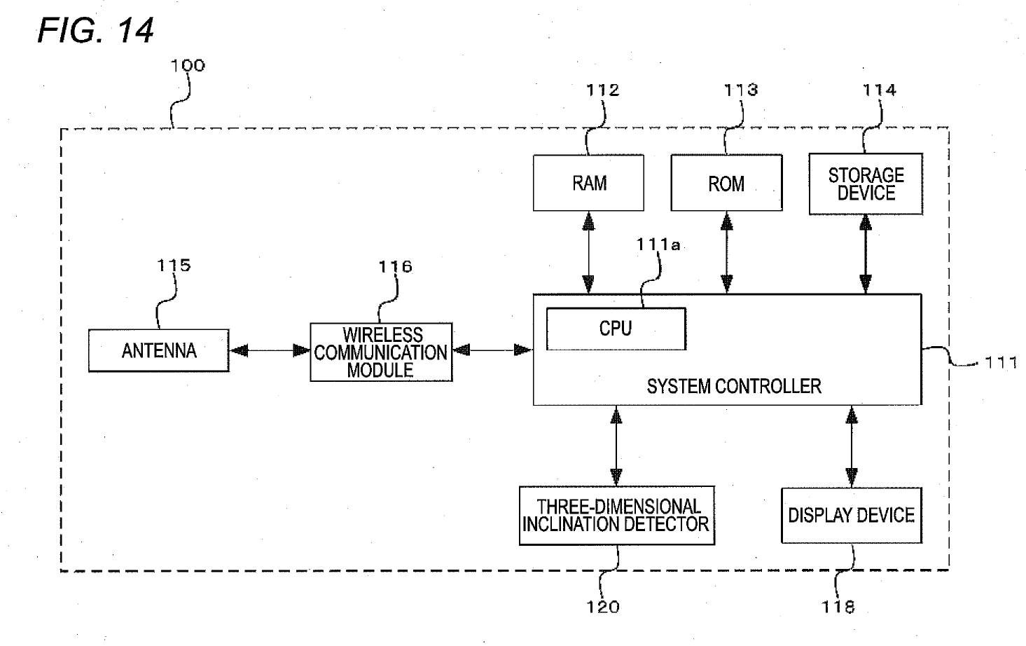

FIG. 14 is a block diagram showing the configuration of a portable device 100 according to the fifth embodiment. As shown in FIG. 14, the fifth embodiment differs from the third embodiment in that the portable device 100 is equipped with a single antenna 115.

The ROM 113 stores information regarding which application programs are correlated with the respective face sections 101 to 106. The system controller 111 activates the application program that is correlated with the face section oriented in the direction of gravity on the basis of the detection signal from the three-dimensional inclination detector 120. Since the operation during the close proximity wireless communication in this embodiment is performed in a way similar to that performed at steps S1101 to S1106 in FIG. 11, the description thereof is omitted.

In the fifth embodiment, since the portable device 100 can be configured using only one antenna, i.e., the antenna 115, the configuration of the portable device 100 can be made more simple, more compact and lower in cost. In particular, in a case where communication is made possible using the antenna 115 regardless of which face of the portable device is placed on the host device, that is, in a case where the housing of the portable device is sufficiently small or thin, the method according to the fifth embodiment is used as a method suited for placing the portable device.

Although the embodiments according to the present invention have been described above, the present invention is not limited to the above-mentioned embodiments but can be modified variously.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless communication apparatus comprising:
a communication module configured to perform close proximity wireless communication with an external device;
a communication detector configured to detect whether the close proximity wireless communication is established by the communication module;
an orientation detector configured to detect an orientation of the apparatus; and
a processor configured to perform processing with the communication module while the close proximity wireless communication is established based on the orientation detected by the orientation detector.

2. The apparatus of claim 1, wherein the orientation detector is configured to detect a change in the orientation of the apparatus by detecting the orientation of the apparatus at a first timing and a second timing, and
wherein the processor is configured to perform the processing based on the detected change.

3. The apparatus of claim 2 further comprising a display device configured to display a menu screen at the first timing, the menu screen indicating available processing.

4. The apparatus of claim 3, wherein the communication module is configured to perform the close proximity wireless communication during a period between the first timing and the second timing.

5. The apparatus of claim 2, wherein the orientation detector is configured to detect the orientation of the apparatus at the second timing when the communication module reestablishes the close proximity wireless communication with the external device.

6. A wireless communication apparatus configured to perform close proximity wireless communication with an external device, the apparatus comprising:
a storage module configured to store a plurality of application programs for performing the close proximity wireless communication, the application programs being correlated with orientations in which the apparatus can be positioned;
an orientation detector configured to detect a current orientation of the apparatus; and
a communication module configured to perform the close proximity wireless communication with the external device using the application programs selected based on the current orientation detected by the orientation detector.

7. The apparatus of claim 6, wherein the orientation detector is configured to detect the current orientation by detecting a direction of gravity.

8. The apparatus of claim 6, wherein the orientation detector is configured to detect the current orientation by detecting a signal level of a wireless signal received by the communication module from the external device.

9. The apparatus of claim 6 further comprising a notification module configured to notify the application program being used by the communication module to the external device.

10. The apparatus of claim 7, wherein the communication module comprises multiple antennas and configured to perform the close proximity wireless communication using one of the antennas selected based on the current orientation.
